(19) United States
(12) Patent Application Publication
(10) Pub. No.: US 2019/0134591 A1
(43) Pub. Date: May 9, 2019

(54) Microcarrier Forming Apparatus

(71) Applicant: METAL INDUSTRIES RESEARCH & DEVELOPMENT CENTRE, Kaohsiung City (TW)

(72) Inventors: Zong-Hsin Liu, Kaohsiung City (TW); Cheng-Han Hung, Kaohsiung City (TW); Ying-Chieh Lin, Kaohsiung City (TW); Cheng-Tang Pan, Kaohsiung City (TW); Shiao-Wei Kuo, Kaohsiung City (TW); Yao-Kun Huang, Kaohsiung City (TW)

(21) Appl. No.: 15/854,111

(22) Filed: Dec. 26, 2017

(30) Foreign Application Priority Data
Nov. 3, 2017 (TW) 106138153

(51) Int. Cl. B01J 13/04; B01J 19/00

(52) U.S. Cl. CPC B01J 13/04; B01J 19/0066

(57) ABSTRACT

A microcarrier forming apparatus includes a tank having an inner periphery. A plurality of spoilers is disposed on the inner periphery of the tank. A spray generator includes a spraying end facing an interior of the tank. A stirrer includes a shaft and a fluid driving member. The shaft includes a central axis inclined from a horizontal plane. The fluid driving member is coupled to the shaft and is disposed in the interior of the tank.

### CROSS REFERENCE TO RELATED APPLICATION

The application claims the benefit of Taiwan application serial No. 106138153, filed on Nov. 3, 2017, and the entire contents of which are incorporated herein by reference.

### BACKGROUND

### 1. Technical Field

The present invention relates to a microcarrier forming apparatus and, more particularly, to a microcarrier forming apparatus for producing microcarriers.

### 2. Description of the Related Art

One of the emerging drug delivery technologies uses microparticles having a diameter ranging from 1 μm to 1000 μm as microcarriers. Since the diameters of the microcarriers are small, the first aim is to form microcarriers of uniform diameters to make each microcarrier have the same drug releasing effect.

Current microcarrier formation techniques for producing microcarriers mainly include emulsification, micro fluid passageways, thermospray, and electrospray. The emulsification technique includes dissolving a polymer in an organic solvent to serve as an oil-phase solution. Then, a water-phase solution is added. After proper stirring, semi-cured spherical microcarriers are formed. However, the microcarriers have diverse diameters after taking shape, and a large quantity of waste material is generated due to poor uniformity in the diameters. The micro fluid passageway technique uses a water-phase solution to shear the oil-phase solution. Although microcarriers of good diameter uniformity are produced, disadvantages including easy formation of a clod of semi-cured microcarriers due to aggregation and adherence, slow formation speed of microcarriers, difficulties in processing the micro fluid passageways, and easy blockage of the micro fluid passageways. The thermospray technique includes heating a polymer into a liquid state which is ejected by high pressure spraying and then cooled by liquefied nitrogen. The liquid phase solution has a high viscosity and, thus, cannot easily form uniform spheres during the high pressure spraying procedure. The electrospray technique uses an electrostatic force, and a capillary nozzle is used to create uniform electrostatic atomization on charged polymer droplets. However, the distance between the semi-cured microcarriers and a collection board is often insufficient, such that the microcarriers hit the collection board at a high speed and cause damage to a surface of the collection board. Furthermore, the high pressure electric field between the conductive capillary tube and the collection board is apt to be interfered by the ambience.

FIG. 1 shows a conventional microcarrier forming apparatus 9 including a spray generator 91, a tank 92, and a stirrer 93. The spray generator 91 includes a fluid passageway 911 having an end with a plurality of fluid outlets 912. The spray generator 91 further includes an amplifying portion 913, a piezoelectric portion 914, and a supersonic wave generator 915. The amplifying portion 913 and the piezoelectric portion 914 are contiguous to each other and are mounted around the fluid passageway 911. Furthermore, the amplifying portion 913 is adjacent to the plurality of fluid outlets 912, and the supersonic wave generator 915 is connected to the piezoelectric portion 914. The plurality of fluid outlets 912 faces a top opening of the tank 92. The stirrer 93 is rotatably mounted in the tank 92. An example of such a microcarrier forming apparatus 9 is disclosed in Taiwan Patent Application No. 105132934 entitled “MICROPARTICLE NOZZLE”.

The tank 92 receives a water-phase fluid F1. An oil-phase fluid F2 is filled into the fluid passageway 911 and forms a liquid film at each of the plurality of fluid outlets 912 by the surface tension. Then, the supersonic wave generator 915 is activated to transmit the high frequency electric energy to the piezoelectric portion 914 that coverts the high frequency electric energy into vibrational energy. The vibrational energy is transmitted and amplified by the amplifying portion 913 connected to the piezoelectric portion 914. The liquid films at the plurality of fluid outlets 912 absorb the vibrational energy until the surface tension is overcome, forming a plurality of microdroplets that falls into the tank 92 and that is enveloped by the water-phase fluid F1, thereby forming a plurality of microcarrier semi-product P. After a number of microcarrier semi-products P are accumulated in the tank 92, the microcarrier semi-products P are collected and dried to evaporate the water-phase fluid F1 forming the outer layer of each microcarrier semi-product P, obtaining a plurality of microcarrier products merely formed by the oil-phase fluid F2. Thus, the conventional microcarrier forming apparatus 9 can mass produce microcarriers of uniform diameters and having an intact appearance.

However, the axis of the stirrer 93 is orthogonal to the liquid surface of the water-phase fluid F1 in the tank 92 that has a smooth inner periphery. When the stirrer 93 operates, the water-phase fluid F1 in the tank 91 is apt to create a swirling flow field, such that a number of microcarrier semi-products P are apt to accumulate in a position adjacent to the axis of the stirrer 93, causing formation of a clod of semi-cured microcarriers due to aggregation and adherence.

In view of the above, improvement to the conventional microcarrier forming apparatuses is necessary.

### SUMMARY

To solve the above problem, the present invention provides a microcarrier forming apparatus that effectively avoids the water-phase fluid from creating the swirling flow field, such that the microcarrier semi-products in the tank can be more uniformly dispersed in the water-phase fluid and is less likely to form a clod of microcarriers due to aggregation and adherence.

A microcarrier forming apparatus according to the present invention includes a tank having an inner periphery. A plurality of spoilers is disposed on the inner periphery of the tank. A spray generator includes a spraying end facing an interior of the tank. A stirrer includes a shaft and a fluid driving member. The shaft includes a central axis inclined from a horizontal plane. The fluid driving member is coupled to the shaft and is disposed in the interior of the tank.

Thus, the microcarrier forming apparatus according to the present invention can effectively avoid the water-phase fluid from creating a swirling flow field, such that the plurality of microcarrier semi-products can be more uniformly dispersed in the water-phase fluid and is less likely to form a clod due to aggregation and adherence. This assures that the plurality of microcarrier products has more uniform diameters and has an integral appearance, increasing the yield of the microcarriers.

In an example, the plurality of spoilers includes an even number of spoilers that are symmetrically disposed to increase stirring uniformity of the water-phase fluid.

In an example, the spray generator includes an equipment using supersonic wave energy to create a standing wave effect to thereby induce an oriented microdroplet spray. Thus, the oil-phase fluid can be ejected by the spray generator as microdroplets in a soft spray at a low speed towards the water-phase fluid in the tank, increasing the integrity of the appearance of the microcarriers.

In an example, the tank includes a bottom board, each of the plurality of spoilers has a vertical height, and a reference plane passes through a half of the vertical height of each of the plurality of spoilers. The fluid driving member includes two blade units. One of the two blade units is disposed between the bottom board and the reference plane, and another of the two blade units is disposed above the reference plane, increasing the stirring uniformity of the water-phase fluid.

In an example, each of the plurality of spoilers has a maximum thickness in a radial direction toward a central axis of the tank, and a ratio of the vertical height of each of the plurality of spoilers to the maximum thickness is in a range between 6.5 and 7.5, increasing the stirring uniformity of the water-phase fluid.

In an example, a ratio of a maximum width of each of the plurality of spoilers to the maximum thickness is in a range between 3 and 5 to increase the stirring uniformity of the water-phase fluid.

In an example, each of the two blade units includes a central portion coupled to the shaft and a plurality of blades disposed on an outer periphery of the shaft at regular angular intervals, increasing the stirring uniformity of the water-phase fluid.

In an example, the tank has an inner diameter, each of the two blade units has a maximum span, and a ratio of the maximum span to the inner diameter is in a range between 0.35 and 0.45, increasing the stirring uniformity of the water-phase fluid.

In an example, the shaft rotates at a speed of 100-500 rpm, increasing the stirring uniformity of the water-phase fluid.

In an example, the tank includes a vertical axis coplanar to the central axis of the shaft, the vertical axis is at an angle to the central axis, and the angle is not equal to 0°. This avoids the water-phase fluid from creating a swirling flow field.

In an example, the angle is between 5° and 45° to increase the stirring uniformity of the water-phase fluid

The present invention will become clearer in light of the following detailed description of illustrative embodiments of this invention described in connection with the drawings.

### BRIEF DESCRIPTION OF THE DRAWINGS

FIG. 1 is a diagrammatic view of a conventional microcarrier forming apparatus.

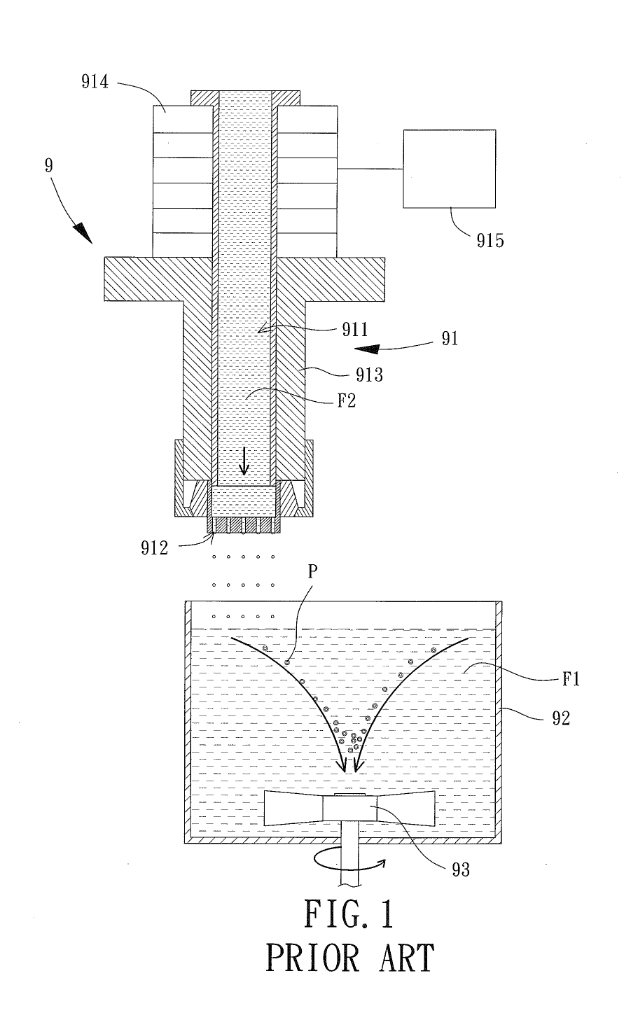

FIG. 2 is a diagrammatic view of a microcarrier forming apparatus of an embodiment according to the present invention.

FIG. 3 is a diagrammatic view illustrating operation of the microcarrier forming apparatus of FIG. 2.

FIG. 4 is a cross sectional view taken along section line A-A of FIG. 3.

### DETAILED DESCRIPTION

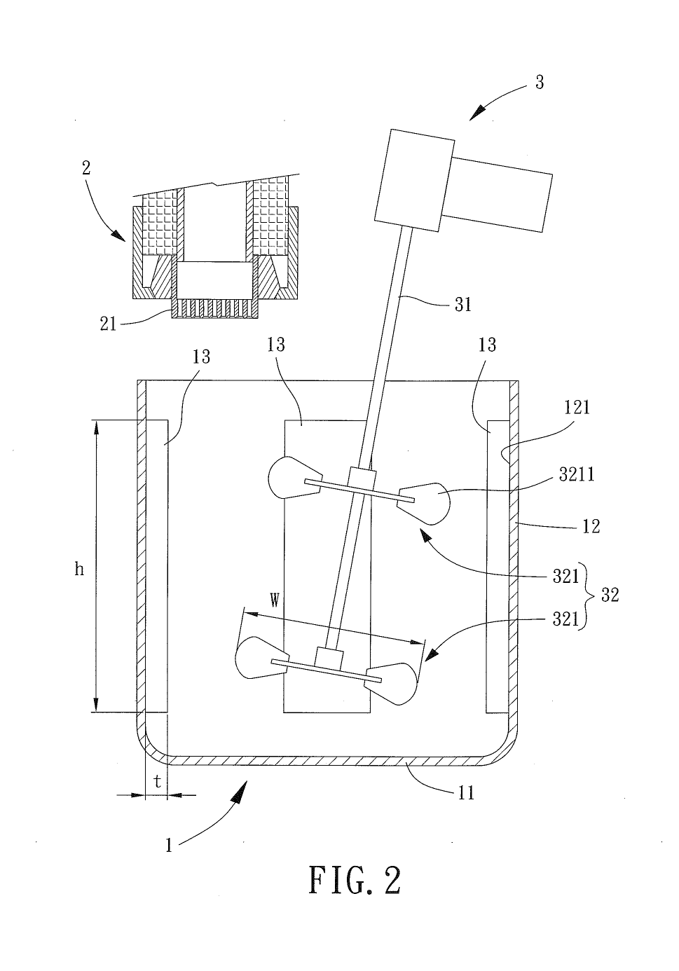

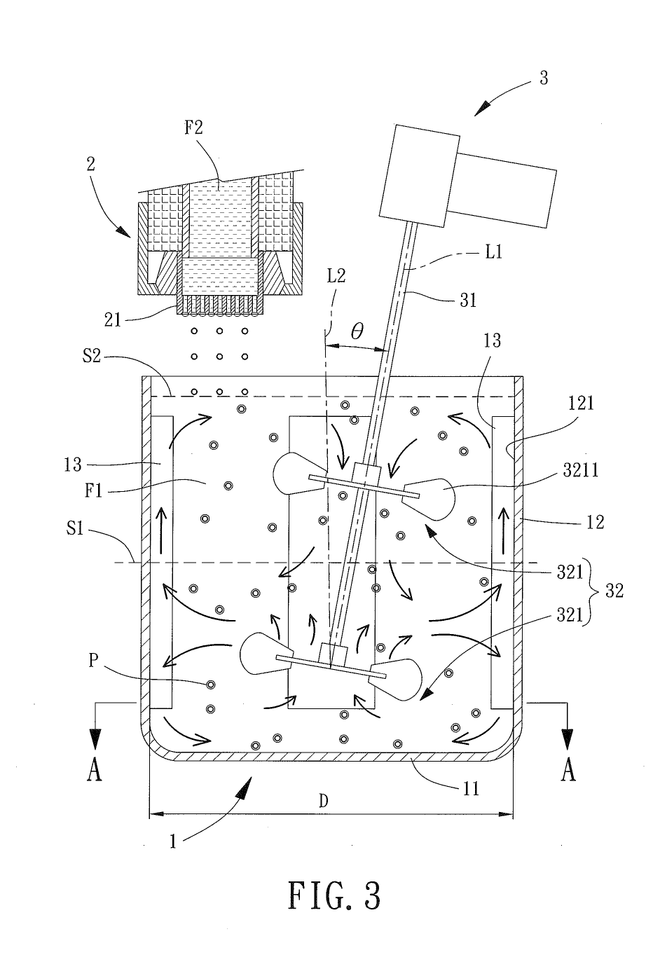

With reference to FIGS. 2 and 3, a microcarrier forming apparatus of an embodiment according to the present invention includes a tank 1, a spray generator 2, and a stirrer 3. The tank 1 receives a water-phase fluid F1. The spray generator 2 ejects an oil-phase fluid F2 into the water-phase fluid F1 in the tank 1. The stirrer 3 stirs the water-phase fluid F1 in the tank 1.

The type of the tank 1 receiving the water-phase fluid F1 is not limited. In this embodiment, the tank 1 includes a bottom board 11 and an annular wall 12 connected to the bottom board 11, with the bottom board 11 and the annular wall 12 together defining a space for receiving the water-phase fluid F1. A plurality of spoilers 13 is mounted in the tank 1 and can be disposed on the inner periphery of the tank 1. Preferably, an even number of spoilers 13 is symmetrically disposed.

The spray generator 2 can be an equipment that uses a standing wave effect (capillary waves) to induce an oriented microdroplet spray. In a non-restrictive example, the spray generator 2 uses supersonic wave energy to provide the standing wave effect. The spray generator 2 receives the oil-phase fluid F2 and includes a spraying end 21 facing an interior of the tank 1. Namely, the spraying end 21 of the spray generator 2 and the fluid level of the water-phase fluid F1 in the tank 1 can have a fixed spacing therebetween to permit spraying of oil-phase microdroplets into the water-phase fluid F1. Alternatively, the spraying end 21 of the spray generator 2 extends into water-phase fluid F1 and is immersed in the water-phase fluid F1, such that the oil-phase microdroplets can be directly ejected in the water-phase fluid F1.

It is particularly noted that the number of the nozzles of the spraying end 21 of the spray generator 2 is not limited in the present invention, and the spraying end 21 can be of a planar type permitting installation of a number of nozzles or a conic type permitting installation of a single nozzle. Thus, the spraying end 21 is not limited to the type illustrated in the drawings.

The stirrer 3 includes a shaft 31 and a fluid driving member 32. The fluid driving member 32 is coupled to the shaft 31 and is mounted in the tank 1. The shaft 31 drives the fluid driving member 32 to rotate to thereby stir the water-phase fluid F1 in the tank 1. The type of the fluid driving member 32 is not limited in the present invention. For example, the fluid driving member 32 includes two blade units 321. Each of the two blade units 321 includes a central portion coupled to the shaft 31 and a plurality of blades 3211 disposed on an outer periphery of the shaft 31. Preferably, each of the two blade units 321 includes 2-4 blades disposed on the outer periphery of the shaft 31 at regular angular intervals. Furthermore, each of the plurality of spoilers 13 has a vertical height h. A reference plane S1 passes through a half of the vertical height h of each of the plurality of spoilers 13. One of the two blade units 321 is disposed between the bottom board 11 and the reference plane S1, and the other blade unit 321 is disposed above the reference plane S1, increasing stirring uniformity of the water-phase fluid F1.

Furthermore, the shaft 31 includes a central axis L1 inclined from a horizontal plane S2. Namely, the tank 1 includes numerous vertical axes L2. After the shaft 31 of the stirrer 3 is inserted into to the interior of the tank 1, the central axis L1 of the shaft 31 is coplanar to one of the vertical axes L2. When installing or operating the stirrer 3, the central axis L1 should be an angle θ to the vertical axes L2 to obliquely extend the shaft 31 through the water-phase fluid F1, with the angle θ being not equal to 0°.

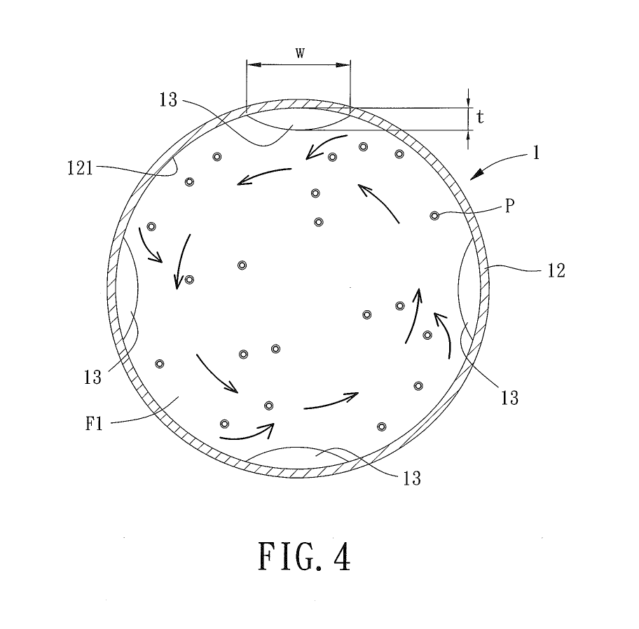

With reference to FIGS. 3 and 4, in use of the microcarrier forming apparatus of the embodiment, the oil-phase fluid F2 is ejected by the spray generator 2 as microdroplets in a soft spray at a low speed towards the water-phase fluid F1 in the tank 1. The water-phase fluid F1 envelops the microdroplets of the oil-phase fluid F2 to form a plurality of microcarrier semi-products P in the tank 1. Each of the plurality of microcarrier semi-products P includes an inner layer formed by the oil-phase fluid F2 and an outer layer formed by the water-phase fluid F1.

By using the shaft 31 inclinedly disposed in the water-phase fluid F1 to drive the fluid driving member 32 to rotate, the water-phase fluid F1 can be continuously stirred without creating a swirling flow field. Furthermore, the plurality of spoilers 13 in the tank 1 creates a stir to the whole flow field, guides the water-phase fluid F1 to form a plurality of vertical flow fields, and guides the ambient water-phase fluid F1 to flow towards the center. Thus, the plurality of microcarrier semi-products P can be more uniformly dispersed in the water-phase fluid F1 and is less likely to form a clod due to aggregation and adherence.

Finally, the plurality of microcarrier semi-products P is collected and dried by hot air and/or other provisions to evaporate the outer layers formed by the water-phase fluid F1, forming a plurality of microcarrier products merely formed by the oil-phase fluid F2. The plurality of microcarrier products has more uniform diameters and has an integral appearance.

With reference to FIGS. 2 and 4, to assure an excellent stirring effect of the water-phase fluid F1, the tank 1, the spray generator 2, and the stirrer 3 of this embodiment are arranged as follows: the angle θ is between 5° and 45°, the rotating speed of the shaft 31 is 100-500 rpm, the tank 1 receives about 1-100 liters of water-phase fluid F1 and has an inner diameter D, each of the two blade units 321 has a maximum span W, and a ratio (W/D) of the maximum span W to the inner diameter D is in a range between 0.35 and 0.45. The number of the spoilers 13 is four (4), and the spoilers 13 are disposed on the inner periphery 121 of the annular wall 12 at regular angular intervals. Each spoiler 13 has a maximum thickness t in a radial direction toward a central axis of the tank 1, a ratio (h/t) of the vertical height h of each of the plurality of spoilers 13 to the maximum thickness t is in a range between 6.5 and 7.5, and a ratio of a maximum width w of each of the plurality of spoilers 13 to the maximum thickness is in a range between 3 and 5.

In view of the foregoing, by using the shaft 31 inclinedly disposed in the water-phase fluid F1 and cooperating the spoilers 13 stirring the flow field, the microcarrier forming apparatus according to the present invention can effectively avoid the water-phase fluid F1 from creating a swirling flow field, such that the plurality of microcarrier semi-products P can be more uniformly dispersed in the water-phase fluid F1 and is less likely to form a clod due to aggregation and adherence. This assures that the plurality of microcarrier products has more uniform diameters and has an integral appearance, increasing the yield of the microcarriers.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A microcarrier forming apparatus comprising:
a tank including an inner periphery, wherein a plurality of spoilers is disposed on the inner periphery of the tank;
a spray generator including a spraying end facing an interior of the tank; and
a stirrer including a shaft and a fluid driving member, wherein the shaft includes a central axis inclined from a horizontal plane, and wherein the fluid driving member is coupled to the shaft and is disposed in the interior of the tank.

2. The microcarrier forming apparatus as claimed in claim 1, wherein the plurality of spoilers includes an even number of spoilers, and wherein the even number of spoilers are symmetrically disposed.

3. The microcarrier forming apparatus as claimed in claim 1, wherein the spray generator includes an equipment using supersonic wave energy to create a standing wave effect to thereby induce an oriented microdroplet spray.

4. The microcarrier forming apparatus as claimed in claim 1, wherein the tank includes a bottom board, wherein each of the plurality of spoilers has a vertical height, wherein a reference plane passes through a half of the vertical height of each of the plurality of spoilers, wherein the fluid driving member includes two blade units, wherein one of the two blade units is disposed between the bottom board and the reference plane, and wherein another of the two blade units is disposed above the reference plane.

5. The microcarrier forming apparatus as claimed in claim 4, wherein each of the plurality of spoilers has a maximum thickness in a radial direction toward a central axis of the tank, and wherein a ratio of the vertical height of each of the plurality of spoilers to the maximum thickness is in a range between 6.5 and 7.5.

6. The microcarrier forming apparatus as claimed in claim 5, wherein a ratio of a maximum width of each of the plurality of spoilers to the maximum thickness is in a range between 3 and 5.

7. The microcarrier forming apparatus as claimed in claim 4, wherein each of the two blade units includes a central portion coupled to the shaft and a plurality of blades disposed on an outer periphery of the shaft at regular angular intervals.

8. The microcarrier forming apparatus as claimed in claim 4, wherein the tank has an inner diameter, wherein each of the two blade units has a maximum span, and wherein a ratio of the maximum span to the inner diameter is in a range between 0.35 and 0.45.

9. The microcarrier forming apparatus as claimed in claim 1, wherein the shaft rotates at a speed of 100-500 rpm.

10. The microcarrier forming apparatus as claimed in claim 1, wherein the tank includes a vertical axis coplanar to the central axis of the shaft, wherein the vertical axis is at an angle to the central axis, and wherein the angle is not equal to 0°.

11. The microcarrier forming apparatus as claimed in claim 10, wherein the angle is between 5° and 45°.
